(19) United States
(12) Patent Application Publication
(10) Pub. No.: US 2010/0179248 A1
(43) Pub. Date: Jul. 15, 2010

(54) AQUEOUS SLURRIES OF FINELY DIVIDED FILLERS, A PROCESS FOR THEIR PREPARATION AND THEIR USE FOR THE PRODUCTION OF PAPERS HAVING A HIGH FILLER CONTENT AND HIGH DRY STRENGTH

(75) Inventors: Anton Esser, Limburgerhof (DE); Hans-Joachim Haehnle, Neustadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/667,046

(22) PCT Filed: Jul. 4, 2008
(86) PCT No.: PCT/EP08/58643

§ 371 Date: Dec. 29, 2009

(30) Foreign Application Priority Data
Jul. 5, 2007 (EP) 07111859.0

(51) Int. Cl. C08K 9/04

(52) U.S. Cl. 523/205

(57) ABSTRACT

Aqueous slurries of finely divided fillers which are at least partly coated with a composition comprising at least one water-soluble amphoteric copolymer and at least one swollen starch.

The invention relates to aqueous slurries of finely divided fillers which are at least partly coated with a composition comprising at least one water-soluble amphoteric copolymer and at least one swollen starch, and a process for their preparation and their use as an additive to the paper stock in the production of papers having high filler content and high dry strength.

In the production of filler-containing papers, the filler slurry is added to the fiber suspension before this is passed on to the former of the paper machine. As a rule, a retention aid or retention aid system is added to the filler/fiber suspension in order to retain as much filler as possible in the paper sheet. The addition of the filler to the paper enables the papermaker to achieve numerous improvements of the sheet properties. These include properties such as opacity, whiteness, haptic properties and printability.

If, in addition, the filler is cheaper than the fiber, the addition or increased addition of filler can lead to a reduction in the proportion of fiber and hence to a reduction in the production costs of paper. Filler-containing paper or papers having a particularly high filler content can be more easily dried than papers which do not contain filler and than papers having a lower filler content. As a consequence of this, the paper machine can be operated more rapidly and with lower steam consumption, which both increases the productivity and reduces the costs.

However, the addition of filler to the fiber suspension also has disadvantages which can only be partly compensated by the addition of further paper assistants. For a given basis weight, there are limits with regard to the amount of filler which can be used. The strength properties of the paper are usually the most important parameters which limit the amount of filler in the paper. Other factors too, such as the filler retention, the drainage of the paper stock suspension and any increased chemical demand during retention and sizing, can play a role here.

The loss of strength properties of paper can be completely or partly compensated in some cases by the use of dry and wet strength agents. A customary procedure is the addition of cationic starch as a dry strength agent to the paper stock. Synthetic dry and wet strength agents, for example based on cationic or anionic polyacrylamides, are also used. The added amount and the strengthening effect are, however, limited in most cases. Equally, the compensating effect with respect to the loss of strength by increasing the filler and therefore also the increase in filler which is at all realizable is also limited. In addition, not all strength properties are enhanced to the same degree and in some cases they are insufficiently enhanced by the use of dry strength agents. An important example of this is the tear strength, which is influenced only slightly by the use of starch or synthetic dry strength agents in comparison with other strength parameters. On the other hand, the increase in the filler content in the paper generally has a very strong adverse effect on the tear strength.

Further important properties are the thickness and the stiffness of the paper. With the same basis weight, the increase of the filler content leads to an increase in paper density and a decrease in the thickness of the paper sheet. The latter leads to a considerable decrease in the paper stiffness. In many cases, this decrease in the paper stiffness cannot be compensated by the use of dry strength agents alone. Frequently, additional measures, such as, for example, the reduction of the mechanical pressure in the press section in the calendering units, in calenders or in the dry end of the paper machine, are necessary. The latter completely or partly compensates the loss of thickness by increasing the filler.

Some filler systems are described in the literature. WO 01/86067 A1 discloses the modification of fillers with hydrophobic polymers, the filler particles being coated with the hydrophobic polymer. The hydrophobic polymers according to WO 01/86067 A1 are starch-containing. The papers produced therewith have improved properties, such as wet strength.

JP-A 08059740 discloses that amphoteric water-soluble polymers are added to aqueous suspensions of inorganic particles, at least a part of the polymers being adsorbed on the filler surface. The amphoteric polymers are preferably prepared by hydrolysis of copolymers of N-vinylformamide, acrylonitrile and acrylic acid in the presence of acids. They comprise from 20 to 90 mol % of amidine units of the structure

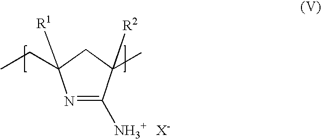

where R¹ and R² are each H or a methyl group and X⁻ is an anion. The filler slurries treated with such polymer are added to the paper stock in the production of filler-containing papers. The filler treatment leads to an improvement in the drainage of the paper stock and also results in an improvement in various strength properties of the dried paper and an improvement in the filler retention.

US 2002/0088579 A1 describes the pretreatment of inorganic fillers with cationic, anionic and amphoteric (zwitterionic) polymers. In every case, the treatment consists of at least two stages. First the treatment with a cationic polymer and then the treatment with an anionic polymer are recommended. In further steps, further cationic and anionic polymers can be adsorbed again alternately. The aqueous suspensions with the pretreated filler particles are added to the paper stock in the production of filler-containing paper. The filler treatment leads to an improvement in various strength properties of the dried paper.

WO 04/087818 A1 describes aqueous slurries of finely divided fillers which are at least partly coated with polymer and which are obtainable by treating aqueous slurries of finely divided fillers with at least one water-soluble amphoteric copolymer which is obtainable by copolymerization of
a) at least one N-vinylcarboxamide of the formula

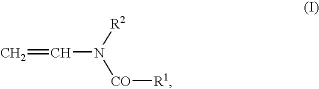

where R¹ and R² are H or C₁- to C₆-alkyl,
b) at least one monoethylenically unsaturated carboxylic acid having 3 to 8 carbon atoms in the molecule and/or alkali metal, alkaline earth metal or ammonium salts thereof, and, if appropriate,
c) other monoethylenically unsaturated monomers which are free of nitrile groups and, if appropriate,
d) compounds which have at least two ethylenically unsaturated double bonds in the molecule,
   and subsequent partial or complete elimination of the groups —CO—R¹ from the monomers (I) incorporated in the form of polymerized units in the copolymer.

WO 05/012637 A1 discloses aqueous compositions comprising at least one finely divided filler and at least one water-soluble amphoteric copolymer which is obtainable by copolymerization of a monomer mixture comprising
a) at least one N-vinylcarboxamide of the general formula

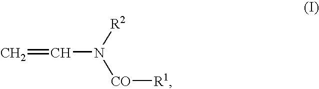

where R¹ and R², independently of one another, are H or C₁- to C₆-alkyl,
b) at least one monomer which is selected from monoethylenically unsaturated sulfonic acids, phosphonic acids, phosphoric acid esters and derivatives thereof,
c) if appropriate, at least one monomer which is selected from monoethylenically unsaturated mono- and dicarboxylic acids, salts thereof and dicarboxylic anhydrides,
d) if appropriate, at least one monoethylenically unsaturated monomer which differs from the components a) to c) and is free of nitrile groups, and
e) if appropriate, at least one compound which has at least two ethylenically unsaturated double bonds in the molecule,
   with the proviso that the monomer mixture comprises at least one monomer b) or c) having at least one free acid group and/or an acid group in salt form,
   and subsequent partial or complete hydrolysis of the groups —CO—R¹ from the monomers (I) incorporated in the form of polymerized units in the copolymer.

Accordingly, said publications disclose processes which describe the treatment of fillers by amphoteric synthetic polymers before the addition of the filler slurry to the fiber and the subsequent formation of the paper sheet. In particular, WO 04/087818 A1 and WO 05/012637 A1 showed that, with prior treatment of the filler, the paper sheets have a considerable increase in various dry strength parameters, such as, for example, the breaking length and the internal bonding strength.

WO 03/087472 A1 discloses a process which describes the treatment of fillers with a composition consisting of swollen starch particles and latices. The latices used in this publication are water-insoluble and are present in the form of a dispersion. After separate preparation of this composition, it is added to the filler slurry; finally, the addition to the fiber and the sheet formation are effected. According to the teaching of WO 03/087472 A1, the starch particles are swollen starch particles. Furthermore, the composition may also comprise other coadditives, such as anionic or cationic coadditives. Water-soluble amphoteric copolymers are not disclosed in WO 03/087472 A1.

It was therefore the object of the present invention to provide further alternative aqueous slurries of finely divided fillers which can be used in the production of paper having a high filler content. The papers produced therewith should have strength properties which are comparable with those of conventional papers having a low filler content. These strength properties include in particular the dry breaking length, the internal bonding strength and the stiffness of the paper.

The object is achieved, according to the invention, by aqueous slurries of finely divided fillers which are at least partly coated with a composition comprising at least one water-soluble amphoteric copolymer and at least one swollen starch.

In a first preferred embodiment (embodiment A) the aqueous slurries according to the invention are obtainable by treating aqueous slurries of finely divided fillers with at least one water-soluble amphoteric copolymer and at least one swollen starch, the water-soluble amphoteric copolymer being obtainable by copolymerization of a monomer mixture of
(a) at least one N-vinylcarboxamide of the general formula

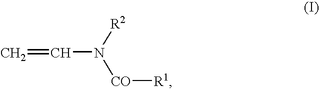

where R¹ and R², independently of one another, are H or C₁- to C₆-alkyl,
(b) at least one monomer which is selected from the group consisting of
   (b₁) monoethylenically unsaturated sulfonic acids, phosphonic acids, phosphoric acid esters and derivatives thereof and
   (b₂) monoethylenically unsaturated mono- and dicarboxylic acids, salts thereof and dicarboxylic anhydrides,
(c) if appropriate, at least one monoethylenically unsaturated monomer differing from the components (a) and (b), and
(d) if appropriate, at least one compound which has at least two ethylenically unsaturated double bonds in the molecule,
   with the proviso that the monomer mixture comprises at least one monomer (b) having at least one free acid group and/or an acid group in salt form,
   and subsequent partial or complete hydrolysis of the groups —CO—R¹ from the monomers (a) incorporated in the form of polymerized units in the copolymer.

In another, second preferred embodiment (embodiment B) the aqueous slurries according to the invention are obtainable by treating aqueous slurries of finely divided fillers with at least one water-soluble amphoteric copolymer and at least one swollen starch, the water-soluble amphoteric copolymer being obtainable by copolymerization of a monomer mixture of
(b) at least one monomer which is selected from the group consisting of
   (b₁) monoethylenically unsaturated sulfonic acids, phosphonic acids, phosphoric acid esters and derivatives thereof, and
   (b₂) monoethylenically unsaturated mono- and dicarboxylic acids, salts thereof and dicarboxylic anhydrides,
(e) at least one ethylenically unsaturated monomer which carries a cationic group and/or a group to which a cationic charge can be imparted by protonation,
(f) if appropriate, at least one monoethylenically unsaturated monomer differing from the components (b) and (e), and
(d) if appropriate, at least one compound which has at least two ethylenically unsaturated double bonds in the molecule.

The aqueous slurries comprise, for example, from 1 to 70% by weight, preferably from 5 to 50% by weight, particularly preferably from 10 to 40% by weight, of at least one finely divided filler. The amount of water-soluble amphoteric copolymer is, for example, from 0.01 to 5% by weight, preferably from 0.05 to 2.5% by weight, particularly preferably from 0.05 to 1% by weight, based on the filler. The metered amount of the starch is, for example, from 0.1 to 10% by weight, preferably from 0.5 to 5% by weight, based on the filler.

The present invention furthermore relates to a process for the preparation of the aqueous slurries, an aqueous slurry of at least one finely divided filler being treated with from 0.01 to 5% by weight, based on the filler, of at least one water-soluble amphoteric copolymer and with from 0.1 to 10% by weight, based on the filler, of at least one swollen starch.

In a first preferred embodiment of the process according to the invention, the aqueous slurries of embodiment A are obtainable by treating aqueous slurries of finely divided fillers with at least one water-soluble amphoteric copolymer and at least one swollen starch, the water-soluble amphoteric copolymer being obtainable by copolymerization of a monomer mixture of
(a) at least one N-vinylcarboxamide of the general formula

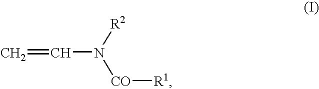

where R¹ and R², independently of one another, are H or C₁- to C₆-alkyl,
(b) at least one monomer which is selected from the group consisting of
   (b₁) monoethylenically unsaturated sulfonic acids, phosphonic acids, phosphoric acid esters and derivatives thereof and
   (b₂) monoethylenically unsaturated mono- and dicarboxylic acids, salts thereof and dicarboxylic anhydrides,
(c) if appropriate, at least one monoethylenically unsaturated monomer differing from the components (a) and (b), and
(d) if appropriate, at least one compound which has at least two ethylenically unsaturated double bonds in the molecule,
   with the proviso that the monomer mixture comprises at least one monomer (b) having at least one free acid group and/or an acid group in salt form,
   and subsequent partial or complete hydrolysis of the groups —CO—R¹ from the monomers (a) incorporated in the form of polymerized units in the copolymer.

In another, second preferred embodiment of the process according to the invention, aqueous slurries of embodiment B are obtainable by treating aqueous slurries of finely divided fillers with at least one water-soluble amphoteric copolymer and at least one swollen starch, the water-soluble amphoteric copolymer being obtainable by copolymerization of a monomer mixture of
(b) at least one monomer which is selected from the group consisting of
   (b₁) monoethylenically unsaturated sulfonic acids, phosphonic acids, phosphoric acid esters and derivatives thereof, and
   (b₂) monoethylenically unsaturated mono- and dicarboxylic acids, salts thereof and dicarboxylic anhydrides,
(e) at least one ethylenically unsaturated monomer which carries a cationic group and/or a group to which a cationic charge can be imparted by protonation,
(f) if appropriate, at least one monoethylenically unsaturated monomer differing from the components (b) and (e), and
(d) if appropriate, at least one compound which has at least two ethylenically unsaturated double bonds in the molecule.

In the context of the present invention, the expression alkyl comprises straight-chain or branched alkyl groups. Suitable alkyl groups are C₁-C₆-alkyl, such as, for example, methyl, ethyl, propyl, isopropyl, n-butyl, sec-butyl, tert-butyl, 1,1-dimethylethyl, pentyl, 2-methylbutyl, 1,1-dimethylpropyl, 1,2-dimethylpropyl, 2,2-dimethylpropyl, 1-ethyl-propyl, hexyl, 2-methylpentyl, 3-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 2-ethylbutyl, 1,1,2-trimethylpropyl, 1,2,2-trimethylpropyl, 1-ethyl-1-methylpropyl or 1-ethyl-2-methyl-propyl.

The aqueous slurries of embodiment A comprise in each case at least one monomer of groups (a) and (b) and, if appropriate, at least one monomer of group (c) and, if appropriate, at least one monomer of group (d). Below, water-soluble amphoteric copolymers for aqueous slurries of embodiment A are described in more detail.

Examples of monomers of group (a) are open-chain N-vinylamide compounds of the formula (I), such as, for example, N-vinylformamide, N-vinyl-N-methylformamide, N-vinylacetamide, N-vinyl-N-methylacetamide, N-vinyl-N-ethylacetamide, N-vinyl-propionamide and N-vinyl-N-methylpropionamide and N-vinylbutyramide. The monomers of group (a) can be used alone or as a mixture in the copolymerization with the monomers of the other groups.

The aqueous slurries according to the invention comprise at least one monomer of group (b), said monomers being selected from the group consisting of
(b₁) monoethylenically unsaturated sulfonic acids, phosphonic acids, phosphoric acid esters and derivatives thereof, and
(b₂) monoethylenically unsaturated mono- and dicarboxylic acids, salts thereof and dicarboxylic anhydrides.

Suitable monomers of group (b₁) are compounds which have an organic radical having one polymerizable, α,β-ethylenically unsaturated double bond and one sulfo or phosphonic acid group per molecule. The salts and esters of the abovementioned compounds are furthermore suitable. The esters of the phosphonic acids may be the monoesters or the diesters. Suitable monomers (b₁) are furthermore esters of phosphoric acid with alcohols having a polymerizable, α,β-ethylenically unsaturated double bond. One proton or the two remaining protons of the phosphoric acid group can be neutralized by suitable bases or esterified with alcohols which have no polymerizable double bonds.

Suitable bases for partial or complete neutralization of the acid groups of the monomers (b₁) are, for example, alkali metal or alkaline earth metal bases, ammonia, amines and/or alkanolamines. Examples of these are sodium hydroxide, potassium hydroxide, sodium carbonate, potassium carbonate, sodium bicarbonate, potassium bicarbonate, magnesium hydroxide, magnesium oxide, calcium hydroxide, calcium oxide, triethanolamine, ethanolamine, morpholine, diethylenetriamine or tetraethylene-pentamine. Suitable alcohols for esterifying the phosphoric acid are, for example, C₁-C₆-alkanols, such as, for example, methanol, ethanol, n-propanol, isopropanol, n-butanol, sec-butanol, tert-butanol, n-pentanol, n-hexanol and isomers thereof.

The monomers (b₁) include, for example, vinylsulfonic acid, allylsulfonic acid, methallylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acid, acrylamidomethylene-phosphonic acid, 2-acrylamido-2-methylpropanesulfonic acid, vinylphosphonic acid, CH₂═CH—NH—CH₂—PO₃H, monomethyl vinylphosphonate, dimethyl vinylphosphonate, allylphosphonic acid, monomethyl allylphosphonate, dimethyl allylphosphonate, acrylamidomethylpropylphosphonic acid, (meth)acryloylethylene glycol phosphate and monoallyl phosphate.

If exclusively monomers in which all protons of the acid groups are esterified, such as, for example, dimethyl vinylphosphonate or dimethyl allylphosphonate, are used as component (b₁), at least one monoethylenically unsaturated mono- and/or dicarboxylic acid or a salt thereof is used for the polymerization, as will be described below as component (b₂). Thus, it is ensured that the copolymers used according to the invention have anionogenic/anionic groups. Alternatively, it is also possible to choose the conditions for the hydrolysis so that some of the ester groups are eliminated.

The abovementioned monomers (b₁) can be used individually or in the form of any desired mixtures.

Suitable monomers of group (b₂) are monoethylenically unsaturated carboxylic acids having 3 to 8 carbon atoms and the water-soluble salts, such as alkali metal, alkaline earth metal or ammonium salts, of these carboxylic acids and the monoethylenically unsaturated carboxylic anhydrides. This group of monomers includes, for example, acrylic acid, methacrylic acid, dimethacrylic acid, ethacrylic acid, α-chloroacrylic acid, maleic acid, maleic anhydride, fumaric acid, itaconic acid, mesaconic acid, citraconic acid, glutaconic acid, aconitic acid, methylenemalonic acid, allylacetic acid, vinylacetic acid and crotonic acid. The monomers of this group (b₂) can be used alone or as a mixture with one another, in partly or completely neutralized form, in the copolymerization. Bases suitable for the neutralization are those mentioned in the case of component (b₁).

According to the invention, the water-soluble amphoteric copolymer comprises at least one monomer from the group (b) which is selected from the subgroups (b₁) and (b₂). Of course, the water-soluble amphoteric copolymer may also comprise mixtures of monomers from the subgroups (b₁) and (b₂).

The copolymers can, if appropriate, comprise at least one further monomer of group (c) incorporated in the form of polymerized units for modification. These monomers are preferably selected from esters of α,β-ethylenically unsaturated mono- and dicarboxylic acids with C₁-C₃₀-alkanols, C₂-C₃₀-alkanediols and C₂-C₃₀-amino alcohols, amides of α,β-ethylenically unsaturated monocarboxylic acids and the N-alkyl- and N,N-dialkyl derivatives thereof, nitriles of α,β-ethylenically unsaturated mono- and dicarboxylic acids, esters of vinyl alcohol and allyl alcohol with C₁-C₃₀-monocarboxylic acids, N-vinyllactams, nitrogen-containing heterocycles having α,β-ethylenically unsaturated double bonds, vinyl aromatics, vinyl halides, vinylidene halides, C₂-C₈-monoolefins and mixtures thereof.

Suitable members of this group (c) are moreover, for example, methyl (meth)acrylate, methyl ethacrylate, ethyl (meth)acrylate, ethyl ethacrylate, n-butyl (meth)acrylate, isobutyl (meth)acrylate, tert-butyl (meth)acrylate, tert-butyl ethacrylate, n-octyl (meth)acrylate, 1,1,3,3-tetramethylbutyl (meth)acrylate, ethylhexyl (meth)acrylate and mixtures thereof.

Suitable additional monomers (c) are furthermore the esters of α,β-ethylenically unsaturated mono- and dicarboxylic acids with amino alcohols, preferably C₂-C₁₂-amino alcohols. These may be C₁-C₈-monoalkylated or C₁-C₈-dialkylated on the amine nitrogen. Suitable acid components of these esters are, for example, acrylic acid, methacrylic acid, fumaric acid, maleic acid, itaconic acid, crotonic acid, maleic anhydride, monobutyl maleate and mixtures thereof. Acrylic acid, methacrylic acid and mixtures thereof are preferably used. These include, for example, N-methylamino-methyl (meth)acrylate, N-methylaminoethyl (meth)acrylate, N,N-dimethylaminomethyl (meth)acrylate, N,N-dimethylaminoethyl (meth)acrylate, N,N-diethylaminoethyl (meth)acrylate, N,N-dimethylaminopropyl (meth)acrylate, N,N-diethylaminopropyl (meth)acrylate and N,N-dimethylaminocyclohexyl (meth)acrylate.

Suitable additional monomers (c) are furthermore acrylamide, methacrylamide, N-methyl(meth)acrylamide, N-ethyl(meth)acrylamide, n-propyl(meth)acrylamide, N-(n-butyl)(meth)acrylamide, tert-butyl(meth)acrylamide, n-octyl(meth)acrylamide, 1,1,3,3-tetramethylbutyl(meth)acrylamide, ethylhexyl(meth)acrylamide and mixtures thereof.

2-Hydroxyethyl (meth)acrylate, 2-hydroxyethyl ethacrylate, 2-hydroxypropyl (meth)-acrylate, 3-hydroxypropyl (meth)acrylate, 3-hydroxybutyl (meth)acrylate, 4-hydroxybutyl (meth)acrylate, 6-hydroxyhexyl (meth)acrylate and mixtures thereof are furthermore suitable as monomers (c).

In addition, N-[2-(dimethylamino)ethyl]acrylamide, N-[2-(dimethylamino)ethyl]meth-acrylamide, N-[3-(dimethylamino)propyl]acrylamide, N-[3-(dimethylamino)propyl]meth-acrylamide, N-[4-(dimethylamino)butyl]acrylamide, N-[4-(dimethylamino)butyl]meth-acrylamide, N-[2-(diethylamino)ethyl]acrylamide, N-[2-(diethylamino)ethyl]meth-acrylamide and mixtures thereof are suitable as further monomers (c).

Further suitable monomers of group (c) are nitriles of α,β-ethylenically unsaturated mono- and dicarboxylic acids, such as, for example, acrylonitrile and methacrylonitrile.

Suitable monomers (c) are furthermore N-vinyllactams and derivatives thereof which may have, for example, one or more C₁-C₆-alkyl substituents (as defined above). These include N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam and mixtures thereof.

Furthermore, N-vinylimidazoles and alkylvinylimidazoles are suitable as monomers (c), in particular methylvinylimidazoles, such as, for example, 1-vinyl-2-methylimidazole, 3-vinylimidazole N-oxide, 2- and 4-vinylpyridine N-oxides and betaine derivatives and quaternization products of these monomers.

Suitable additional monomers are furthermore ethylene, propylene, isobutylene, butadiene, styrene, α-methylstyrene, vinyl acetate, vinyl propionate, vinyl chloride, vinylidene chloride, vinyl fluoride, vinylidene fluoride and mixtures thereof.

The abovementioned monomers (c) can be used individually or in the form of any desired mixtures.

A further modification of the copolymers is possible by using, in the copolymerization, monomers (d) which comprise at least two double bonds in the molecule, e.g. methylenebisacrylamide, glycol diacrylate, glycol dimethacrylate, glyceryl triacrylate, pentaerythrityl triallyl ether, and polyalkylene glycols or polyols, such as pentaerythritol, sobitol or glucose, at least diesterified with acrylic acid and/or methacrylic acid. If at least one monomer of group (d) is used in the copolymerization, the amounts used are up to 2 mol %, e.g. from 0.001 to 1 mol %.

In a preferred embodiment, a monomer mixture is used for the polymerization, the component (b) consisting either only of monomers (b₁) or only of monomers of subgroup (b₂), with the proviso that the monomer mixture comprises at least one monomer (b) having at least one free acid group and/or an acid group in salt form.

In a particularly preferred embodiment, only monomers of subgroup (b₂) are used for the polymerization with the monomers (a) of the formula (I).

The water-soluble amphoteric copolymers used according to the invention for aqueous slurries of embodiment A are obtainable, for example, by free radical copolymerization of
(a) from 1 to 99% by weight, preferably from 5 to 95% by weight, in particular from 20 to 90% by weight, based on the total weight of the monomers used for the polymerization, of at least one N-vinylcarboxamide of the general formula

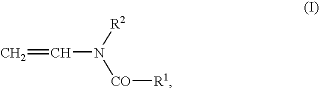

where R¹ and R², independently of one another, are H or C₁- to C₆-alkyl,
(b) from 1 to 99% by weight, preferably from 5 to 95% by weight, in particular from 10 to 80% by weight, based on the total weight of the monomers used for the polymerization, of at least one monomer which is selected from the group consisting of
   (b₁) monoethylenically unsaturated sulfonic acids, phosphonic acids, phosphoric acid esters and derivatives thereof, and
   (b₂) monoethylenically unsaturated mono- and dicarboxylic acids, salts thereof and dicarboxylic anhydrides,
   preferably from 1 to 99% by weight, particularly preferably from 5 to 95% by weight, especially preferably from 10 to 80% by weight, based on the total weight of the monomers used for the polymerization, of at least one monomer which is selected from subgroup (b₂),
(c) from 0 to 30% by weight, preferably from 0.1 to 25% by weight, in particular from 1 to 15% by weight, based on the total weight of the monomers used for the polymerization, of at least one monoethylenically unsaturated monomer differing from the components (a) and (b), and
(d) from 0 to 5% by weight, preferably from 0.0001 to 3% by weight, based on the total weight of the monomers used for the polymerization, of at least one compound which has at least two ethylenically unsaturated double bonds in the molecule,
   with the proviso that the monomer mixture comprises at least one monomer (b) having at least one free acid group and/or an acid group in salt form,
   and subsequent partial or complete hydrolysis of the monomers (a) in the form of polymerized units in the copolymer.

For example, preferred water-soluble amphoteric copolymers for aqueous slurries of embodiment A are those which are prepared by copolymerization of
(a) at least one N-vinylcarboxamide of the general formula

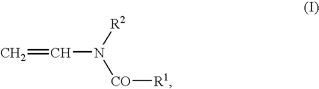

where R¹ and R², independently of one another, are H or C₁- to C₆-alkyl,
(b) at least one monomer from the group (b₂) which is selected from monoethylenically unsaturated carboxylic acids having 3 to 8 carbon atoms and the water-soluble salts, such as alkali metal, alkaline earth metal and ammonium salts, of these carboxylic acids,
(c) if appropriate, at least one monoethylenically unsaturated monomer differing from the components (a) and (b), and
(d) if appropriate, at least one compound which has at least two ethylenically unsaturated double bonds in the molecule,
   and subsequent partial or complete hydrolysis of the groups —CO—R¹ from the monomers (a) incorporated in the form of polymerized units in the copolymer.

Particularly preferred water-soluble amphoteric copolymers for aqueous slurries of embodiment A are those which are obtainable by copolymerization of
(a) N-vinylformamide,
(b) acrylic acid, methacrylic acid and/or the alkali metal or ammonium salts thereof and
(c) if appropriate, other monoethylenically unsaturated monomers,
   and subsequent partial or complete hydrolysis of the vinylformamide units present in the copolymers.

The hydrolysis of the water-soluble amphoteric copolymers for aqueous slurries of embodiment A, which copolymers are obtained by the process described above, is effected by known methods, by the action of acids, bases or enzymes, for example hydrochloric acid, sodium hydroxide solution or potassium hydroxide solution. Here, copolymers which comprise vinylamine units of the formula (II) and/or amidine units of the formula (III) and/or (IV)

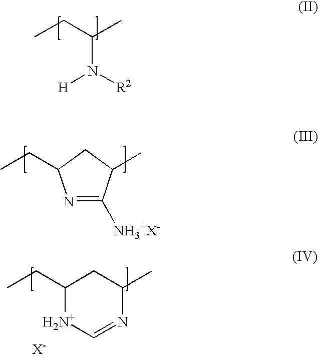

where, in the amidine units (III) and (IV), X⁻ in each case is an anion, form from the monomers (a) of the abovementioned formula (I) which are incorporated in the form of polymerized units, by elimination of the —CO—R¹ group.

The originally anionic copolymer acquires cationic groups thereby and thus becomes amphoteric.

The amidine units (III) and (IV), respectively, form by reaction of neighboring vinylamine units of the formula (II) with vinylformamide units or by reaction of neighboring vinylamine units of the formula (II) with (meth)acrylonitrile groups. The sum of vinylamine and amidine units which are formed from the units of N-vinyl-carboxamides incorporated in the form of polymerized units is always stated for the water-soluble amphoteric copolymers below.

The hydrolysis of the monomers is disclosed, for example, in EP 0 672 212 B1, on page 4, lines 38-58, and on page 5, lines 1-25. Hydrolyzed copolymers for which the hydrolysis was carried out in the presence of bases, preferably in the presence of sodium hydroxide solution, are preferably used. The degree of hydrolysis of the vinylcarboxamide groups incorporated in the form of polymerized units is, for example, from 0.1 to 100 mol %, in general from 1 to 98 mol %, preferably from 10 to 80 mol %. The degree of hydrolysis should particularly preferably be chosen so that cationic and anionic charges in the water-soluble amphoteric copolymer are approximately compensated, the deviation from charge equality being as a rule not more than 20%.

The hydrolyzed copolymers comprise, for example,
(i) from 1 to 98 mol %, preferably from 1 to 75 mol %, of vinylcarboxamide units,
(ii) from 1 to 98 mol %, preferably from 1 to 55 mol %, of units of monoethylenically unsaturated sulfonic acids, phosphonic acids, phosphoric acid esters, or derivatives thereof, or units of monoethylenically unsaturated mono- and dicarboxylic acids, salts thereof and dicarboxylic anhydrides, preferably from 1 to 98 mol %, preferably from 1 to 55 mol % of units of at least one monoethylenically unsaturated carboxylic acid having 3 to 8 carbon atoms,
(iii) from 1 to 98 mol %, preferably from 1 to 55 mol %, of vinylamine units of the formula (II) and/or amidine units of the formula (III) and/or (IV), and
(iv) up to 30 mol % of units of other monoethylenically unsaturated compounds.

Particularly preferred hydrolyzed copolymers are those which comprise
(i) from 5 to 70 mol % of vinylcarboxamide units,
(ii) from 3 to 30 mol % of units of monoethylenically unsaturated sulfonic acids, phosphonic acids and salts thereof, or from 5 to 45 mol % of units of acrylic acid, methacrylic acid, salts and mixtures thereof,
   preferably from 15 to 45 mol % of acrylic acid and/or methacrylic acid units and
(iii) from 10 to 50 mol % of vinylamine units in salt form and/or amidine units of the formula (III) and/or (IV).

As described above, aqueous slurries of embodiment B are also preferred. The aqueous slurries of embodiment B comprise in each case at least one monomer of the groups (b) and (e) and, if appropriate, at least one monomer of the group (f) and, if appropriate, at least one monomer of the group (d). Below, water-soluble amphoteric copolymers for aqueous slurries of embodiment B are described in more detail.

The monomers of group (b) are identical to those of group (b) of the water-soluble amphoteric copolymers for aqueous slurries of embodiment A. Likewise identical in both embodiments A and B are the monomers of group (d), which are compounds which have at least two ethylenically unsaturated double bonds in the molecule.

The lists given above, including the preferred embodiments, therefore apply to the monomers of groups (b) and (d).

Suitable monomers of group (e) are the esters of α,β-ethylenically unsaturated mono- and dicarboxylic acids with amino alcohols, preferably C₂-C₁₂-amino alcohols. These may be C₁-C₈-monoalkylated or C₁-C₈-dialkylated on the amine nitrogen. Suitable acid components of these esters are, for example, acrylic acid, methacrylic acid, fumaric acid, maleic acid, itaconic acid, crotonic acid, maleic anhydride, monobutyl maleate and mixtures thereof. Acrylic acid, methacrylic acid and mixtures thereof are preferably used. These include, for example, N-methylaminomethyl (meth)acrylate, N-methyl-aminoethyl (meth)acrylate, N,N-dimethylaminomethyl (meth)acrylate, N,N-dimethyl-aminoethyl (meth)acrylate, N,N-diethylaminoethyl (meth)acrylate, N,N-dimethylamino-propyl (meth)acrylate, N,N-diethylaminopropyl (meth)acrylate and N,N-dimethylamino-cyclohexyl (meth)acrylate.

The quaternization products of the above compounds with C₁-C₈-alkyl chlorides, C₁-C₈-dialkyl sulfates, C₁-C₁₆-epoxides or benzyl chloride are also suitable.

In addition, N-[2-(dimethylamino)ethyl]acrylamide, N42-(dimethylamino)ethyl]-methacrylamide, N-[3-(dimethylamino)propyl]acrylamide, N-[3-(dimethylamino)propyl]-methacrylamide, N-[4-(dimethylamino)butyl]acrylamide, N-[4-(dimethylamino)butyl]-methacrylamide, N-[2-(diethylamino)ethyl]acrylamide, N42-(diethylamino)ethyl]-methacrylamide and mixtures thereof are suitable as further monomers (e).

The quaternization products of the above compounds with C₁-C₈ alkyl chloride, C₁-C₆-dialkyl sulfate, C₁-C₁₆-epoxides or benzyl chloride are also suitable.

Suitable monomers (e) are furthermore N-vinylimidazoles, alkylvinylimidazoles, in particular methylvinylimidazoles, such as 1-vinyl-2-methylimidazole, 3-vinylimidazole-N-oxide, 2- and 4-vinylpyridines, 2- and 4-vinylpyridine-N-oxides and betaine derivatives and quaternization products of these monomers.

Dialkyldiallylammonium chloride is furthermore suitable as a monomer of group (e).

The abovementioned monomers (e) can be used individually or in the form of any desired mixtures.

Suitable monomers (f) are N-vinylcarboxamides of the general formula (I)

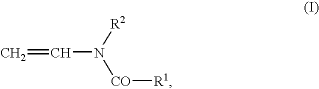

where R¹ and R², independently of one another, are H or C₁- to C₆-alkyl. Suitable open-chain N-vinylamide compounds of the formula (I) are, for example, N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide and N-vinyl-butyramide and mixtures thereof.

Esters of α,β-ethylenically unsaturated mono- and dicarboxylic acids with C₁-C₃₀-alkanols, C₂-C₃₀-alkanediols, amides of α,β-ethylenically unsaturated monocarboxylic acids and the N-alkyl- and N,N-dialkyl derivatives thereof, esters of vinyl alcohol and allyl alcohol with C₁-C₃₀-monocarboxylic acids, vinylaromatics, vinyl halides, vinylidene halides, C₂-C₈-monoolefins and mixtures thereof are furthermore suitable as monomers (f).

Suitable additional monomers (f) are, for example, methyl (meth)acrylate, methyl ethacrylate, ethyl (meth)acrylate, ethyl ethacrylate, n-butyl (meth)acrylate, isobutyl (meth)acrylate, tert-butyl (meth)acrylate, tert-butyl ethacrylate, n-octyl (meth)acrylate, 1,1,3,3-tetramethylbutyl (meth)acrylate, ethylhexyl (meth)acrylate and mixtures thereof.

Suitable additional monomers (f) are furthermore (meth)acrylamides and (meth)acrylonitriles, such as, for example, acrylamide, methacrylamide, N-methyl-(meth)acrylamide, N-ethyl(meth)acrylamide, N-propyl(meth)acrylamide, N-(n-butyl)-(meth)acrylamide, tert-butyl(meth)acrylamide, n-octyl(meth)acrylamide, 1,1,3,3-tetra-methylbutyl(meth)acrylamide, ethylhexyl(meth)acrylamide, acrylonitrile and methacrylonitrile and mixtures thereof.

2-Hydroxyethyl (meth)acrylate, 2-hydroxyethyl ethacrylate, 2-hydroxypropyl (meth)acrylate, 3-hydroxypropyl (meth)acrylate, 3-hydroxybutyl (meth)acrylate, 4-hydroxybutyl (meth)acrylate, 6-hydroxyhexyl (meth)acrylate, etc. and mixtures thereof are suitable as further monomers (f).

Suitable monomers (f) are furthermore N-vinyllactams and derivatives thereof which may have, for example, one or more C₁-C₆-alkyl substituents, such as methyl, ethyl, n-propyl, isopropyl, n-butyl, sec-butyl, ten-butyl, etc. These include, for example, N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, etc.

Suitable additional monomers (f) are furthermore ethylene, propylene, isobutylene, butadiene, styrene, α-methylstyrene, vinyl chloride, vinylidene chloride, vinyl fluoride, vinylidene fluoride and mixtures thereof.

The water-soluble amphoteric copolymers used according to the invention for aqueous slurries of embodiment B are obtainable, for example, by free radical polymerization of
(b) from 1 to 99% by weight, preferably from 5 to 95% by weight, in particular from 10 to 80% by weight, based on the total weight of the monomers used for the polymerization, of at least one monomer which is selected from the group consisting of
   (b₁) monoethylenically unsaturated sulfonic acids, phosphonic acids, phosphoric acid esters and derivatives thereof, and
   (b₂) monoethylenically unsaturated mono- and dicarboxylic acids, salts thereof and dicarboxylic anhydrides,
   from 1 to 99% by weight, preferably from 5 to 95% by weight, in particular from 10 to 80% by weight, based on the total weight of the monomers used for the polymerization, of at least one monomer which is selected from the subgroup (b₂),
(e) from 1 to 99% by weight, preferably from 5 to 95% by weight, in particular from 20 to 90% by weight, based on the total weight of the monomers used for the polymerization, of at least one ethylenically unsaturated monomer which carries a cationic group and/or a group which can acquire a cationic charge by protonation,
(f) from 0 to 30% by weight, preferably from 0.1 to 25% by weight, in particular from 1 to 15% by weight, based on the total weight of the monomers used for the polymerization, of at least one monoethylenically unsaturated monomer differing from the components (b) and (e) and
(d) from 0 to 5% by weight, preferably from 0.0001 to 3% by weight, based on the total weight of the monomers used for the polymerization, of at least one compound which has at least two ethylenically unsaturated double bonds in the molecule.

For example, preferred water-soluble amphoteric copolymers for aqueous slurries of embodiment B are those which are obtainable by copolymerization of
(b) at least one monomer from the group (b₂), which is selected from monoethylenically unsaturated carboxylic acids having 3 to 8 carbon atoms and the water-soluble salts, such as alkali metal, alkaline earth metal and ammonium salts, of these carboxylic acids,
(e) at least one ethylenically unsaturated monomer which is selected from the group consisting of the esters of α,β-ethylenically unsaturated mono- and dicarboxylic acids with C₂-C₁₂-amino alcohols which may be C₁-C₈-monoalkylated or C₁-C₈-dialkylated on the amine nitrogen, and the quaternization products of these esters with C₁-C₈-alkyl chlorides, C₁-C₈-dialkyl sulfates, C₁-C₁₆-epoxides or benzyl chloride,
(f) if appropriate, at least one monoethylenically unsaturated monomer which differs from the components (b) and (e) and is selected from the group consisting of the N-vinylcarboxamides of the general formula (I)

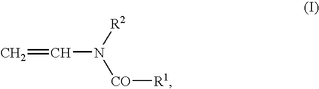

where R¹ and R², independently of one another, are H or C₁- to C₆-alkyl, (meth)acrylamides and (meth)acrylonitriles, and
(d) if appropriate, at least one compound which has at least two ethylenically unsaturated double bonds in the molecule.

Particularly preferred water-soluble amphoteric copolymers for aqueous slurries of embodiment B are those which are obtainable by copolymerization of

(b) acrylic acid, methacrylic acid and/or the alkali metal or ammonium salts thereof,
(e) dimethylaminoethyl (meth)acrylate methochloride,
(f) N-vinylformamide, acrylamide and/or acrylonitrile.

Mixtures in any desired composition of the two embodiments A and B are of course also possible for the preparation of the aqueous slurries according to the invention of finely divided fillers. However, preferably only water-soluble amphoteric copolymers of one embodiment are used.

In addition, embodiments of water-soluble amphoteric copolymers which comprise any desired mixtures of said monomer groups from the two embodiments A and B are also possible.

Regardless of whether they are used in aqueous slurries of embodiment A or B, the water-soluble amphoteric copolymers are prepared by customary processes known to the person skilled in the art. Suitable processes are described, for example, in EP 0 251 182 A1, WO 94/13882 and EP 0 672 212 B1, which is hereby incorporated by reference. Furthermore, reference is made to the preparation of water-soluble amphoteric copolymers described in WO 04/087818 A1 and WO 05/012637.

The water-soluble amphoteric copolymers can be prepared by solution, precipitation, suspension or emulsion polymerization. Solution polymerization in aqueous media is preferred. Suitable aqueous media are water and mixtures of water and at least one water-miscible solvent, e.g. an alcohol, such as methanol, ethanol, n-propanol, etc.

The polymerization temperatures are preferably in a range from about 30 to 200° C., particularly preferably from 40 to 110° C. The polymerization is usually effected under atmospheric pressure but can also take place under reduced or superatmospheric pressure. A suitable pressure range is from 0.1 to 5 bar.

The monomers (b) containing acid groups are preferably used in salt form. For the copolymerization, the pH is preferably adjusted to a value in the range from 6 to 9. By use of a customary buffer or by measurement of the pH and corresponding addition of acid or base, the pH can be kept constant during the polymerization.

For the preparation of the polymers, the monomers can be polymerized with the aid of free radical initiators.

Initiators which may be used for the free radical polymerization are the peroxo and/or azo compounds customary for this purpose, for example alkali metal or ammonium peroxodisulfates, diacetyl peroxide, dibenzoyl peroxide, succinyl peroxide, di-tert-butyl peroxide, tert-butyl perbenzoate, tert-butyl perpivalate, tert-butyl peroxy-2-ethylhexanoate, tert-butyl permaleate, cumyl hydroperoxide, diisopropyl peroxodicarbamate, bis(o-toluoyl) peroxide, didecanoyl peroxide, dioctanoyl peroxide, dilauroyl peroxide, tert-butyl perisobutyrate, tert-butyl peracetate, di-tert-amyl peroxide, tert-butyl hydroperoxide, azobisisobutyronitrile, azobis(2-amidinopropane) dihydro-chloride or 2,2′-azobis(2-methylbutyronitrile). Initiator mixtures or redox initiator systems, such as, for example, ascorbic acid/iron(II) sulfate/sodium peroxodisulfate, tert-butyl hydroperoxide/sodium disulfite, tert-butyl hydroperoxide/sodium hydroxy-methanesulfinate, H₂O₂/CuI, are also suitable.

For adjusting the molecular weight, polymerization can be effected in the presence of at least one regulator. Regulators which may be used are the customary compounds known to the person skilled in the art, such as, for example, sulfur compounds, e.g. mercaptoethanol, 2-ethylhexyl thioglycolate, thioglycolic acid, sodium hypophosphite, formic acid or dodecyl mercaptan and tribromochloromethane or other compounds which have a regulating effect on the molecular weight of the polymers obtained.

The molar mass of water-soluble amphoteric copolymers is, for example, at least 10 000, preferably at least 100 000, dalton and in particular at least 500 000 dalton. The molar masses of the copolymers are then, for example, from 10 000 to 10 million, preferably from 100 000 to 5 million (for example, determined by light scattering). This molar mass range corresponds, for example, to K values of from 5 to 300, preferably from 10 to 250 (determined according to H. Fikentscher in 5% strength aqueous sodium chloride solution at 25° C. and a polymer concentration of 0.1% by weight).

The water-soluble amphoteric copolymers may carry an excess anionic or an excess cationic charge or may be electrically neutral if equal numbers of anionic and cationic groups are present in the copolymer. Depending on the charged state of the water-soluble amphoteric copolymers, the aqueous slurries of fillers prepared therewith are anionic, cationic or electrically neutral if the water-soluble amphoteric copolymers have the same quantity of cationic and anionic charge.

Preferably used water-soluble amphoteric copolymers are those which have a charge density of, preferably, not more than 1 meq/g at pH 7, both in the anionic and in the cationic range.

According to the invention, the water-soluble amphoteric copolymers are used for the treatment of finely divided fillers. Suitable fillers are all pigments which can be used in the paper industry and comprise inorganic material, e.g. calcium carbonate, which can be used in the form of ground lime (GCC), chalk, marble or precipitative calcium carbonate (PCC), talc, kaolin, bentonite, satin white, calcium sulfate, barium sulfate and titanium dioxide. It is also possible to use mixtures of two or more pigments. The median particle diameter is, for example, in the range from 0.5 to 30 μm, preferably from 1 to 10 μm.

The aqueous slurries according to the invention furthermore comprise at least one swollen starch, which is likewise used for the treatment of the finely divided fillers.

Regardless of the type of starch used, this swollen starch is clearly distinguishable from the completely digested starch usually used in the paper industry. In the case of the completely digested starch usually used, the starch grains have completely burst, the starch being present in the form of a molecular dispersion. In contrast, the starch in the aqueous slurries according to the invention is swollen, i.e. the starch particles are swollen but substantially non-fragmented starch particles. The starch is swollen but has retained its granular structure. Starch particles swollen in this manner have as a rule a size in the range from 5 to 90 μm, preferably from 30 to 70 μm, depending on the type of starch used.

Swollen starch is obtained by treatment of an aqueous composition comprising unswollen starch with hot water. This treatment is effected below the gelatinization temperature relevant for the respective types of starch, so that it is ensured that the starch particles only swell and do not burst. The temperature of the added hot water and the residence time of the starch grains in the hot environment are dependent on the type of starch used; as a rule, however, the hot water has temperatures in the range from 50 to 85° C., preferably in the range from 60 to 80° C. and particularly preferably in the range from 70 to 75° C.

The swelling process is stopped after a certain time, which must be determined depending on the type of starch used and the temperature of the hot water, preferably by adding cold water to the warm aqueous starch mixture.

The swelling of the starch is described in WO 03/087472 A1, which is hereby incorporated by reference.

Suitable types of starch are all starches which are customary in the paper industry and may be anionic, cationic or amphoteric. The average molar masses M_{w} of the starches are, for example, in the range from 50 000 to 150 000 000, preferably in the range from 100 000 to 100 000 000, particularly preferably in the range from 200 000 to 50 000 000. The average molecular weights M_{w} of the starches can be determined by methods known to the person skilled in the art, for example by means of gel permeation chromatography using a multiangle scattered light detector.

Suitable types of starch are natural starches, such as potato, wheat, corn, rice or tapioca starch, potato starch being preferred. It is also possible to use chemically modified starches, such as hydroxyethyl or hydroxypropyl starches, or starches which comprise anionic groups, such as, for example, phosphate starch, or cationic starches which comprise quaternary ammonium groups, a degree of substitution DS=0.01 to 0.2 being preferred. The degree of substitution DS indicates the number of cationic groups which are present on average per glucose unit in the starch. Amphoteric starches which comprise both quaternary ammonium groups and anionic groups, such as carboxylate and/or phosphate groups, and which, if appropriate, may also be chemically modified, e.g. hydroxyalkylated or alkyl-esterified, are particularly preferred. The starches can be used individually but also in any desired mixtures with one another.

As described above, the present invention also relates to a process for the preparation of the aqueous slurries. Aqueous slurries are obtained by treating an aqueous slurry of at least one finely divided filler with from 0.01 to 5% by weight, based on the filler, of at least one water-soluble amphoteric copolymer and with from 0.1 to 10% by weight, based on the filler, of at least one swollen starch.

The treatment of the finely divided filler with the water-soluble copolymer and the swollen starch can be effected in various ways. In principle, any conceivable combination of the three components, starch (unswollen or swollen), water-soluble amphoteric copolymer and filler, is possible. In this case it is possible to admix the starch in the unswollen state with one or both of the other components, water-soluble amphoteric copolymer and/or filler, and then to carry out the swelling in the presence of this one or both other components. It is likewise also possible to carry out the swelling of the starch independently of the other components and then to admix the swollen starch with one or both of the other components, water-soluble amphoteric copolymer and/or filler.

For example, the treatment of the aqueous slurry of at least one finely divided filler with at least one water-soluble amphoteric copolymer and at least one swollen starch can be effected as follows:
(A) preparation of an aqueous slurry comprising at least one unswollen starch and at least one water-soluble amphoteric copolymer, subsequent swelling of the starch, addition of an aqueous slurry of at least one finely divided filler to this starch-copolymer composition,
(B) preparation of an aqueous slurry comprising at least one finely divided filler and at least one water-soluble amphoteric copolymer, preparation of an aqueous slurry of at least one unswollen starch, subsequent swelling of the starch, mixing of the two aqueous slurries, or
(C) preparation of an aqueous slurry comprising at least one unswollen starch, swelling of the starch, addition of an aqueous slurry of at least one finely divided filler, subsequent addition of an aqueous solution of at least one water-soluble amphoteric copolymer.

In all variants, the preparation of an aqueous slurry of finely divided filler is first effected. The fillers are processed, for example, by introduction into water to give an aqueous slurry. Precipitated calcium carbonate is usually suspended in water in the absence of dispersants. In order to prepare aqueous slurries of the other fillers, as a rule an anionic dispersant, e.g. polyacrylic acid having an average molar mass M_{w} of, for example, from 1 000 to 40 000 dalton, is used. If an anionic dispersant is used, for example, from 0.01 to 0.5% by weight, preferably from 0.2 to 0.3% by weight, thereof is employed for the preparation of aqueous filler slurries. The finely divided fillers dispersed in water in the presence of anionic dispersants are anionic. The aqueous slurries comprise, for example, from 10 to 30% by weight, in general 15-25% by weight, of at least one filler.

In the first variant (A), an aqueous slurry of at least one unswollen starch is first prepared, which slurry has, for example, a starch content of from 5 to 50% by weight, preferably from 10 to 35% by weight, particularly preferably from 15 to 25% by weight. An aqueous solution of at least one water-soluble amphoteric copolymer is added to this starch slurry. The admixing is preferably effected at room temperature. The metered amount of the at least one water-soluble amphoteric copolymer is, for example, from 0.1 to 30% by weight, preferably from 0.5 to 20% by weight and particularly preferably from 1.0 to 15% by weight, based in each case on the starch. The aqueous slurry comprising at least one unswollen starch and at least one water-soluble amphoteric copolymer is then mixed with hot water so that the temperature of the total mixture is increased and the swelling process of the starch begins. As described above, the swelling of the starch is effected at temperatures below the gelatinization temperature of the respective types of starch so that it is ensured that the starch particles only swell and do not burst. The swelling process is stopped after a certain time which is dependent on the type of starch used and the temperature of the hot water, preferably by adding cold water to the warm aqueous slurry comprising at least one swollen starch and at least one water-soluble amphoteric copolymer. An aqueous slurry of at least one finely divided filler is then added to this aqueous starch-copolymer composition.

In this variant (A), the swelling process can alternatively be stopped by adding the aqueous slurry of at least one finely divided filler directly to the warm aqueous slurry comprising at least one swollen starch and at least one water-soluble amphoteric copolymer. This requires that the aqueous slurry of at least one finely divided filler have a temperature substantially lower than the warm aqueous starch-copolymer composition.

Independently of the possibility of stopping the swelling process, the metered amount of the starch-copolymer composition is, for example, from 0.1 to 15% by weight, preferably from 0.5 to 7.5% by weight, based on the filler.

According to the possible variant (B), an aqueous slurry comprising at least one finely divided filler and at least one water-soluble amphoteric copolymer is first prepared. The metered amount of the water-soluble amphoteric copolymer is, for example, from 0.01 to 5% by weight, preferably from 0.05 to 2.5% by weight, particularly preferably from 0.05 to 1% by weight, based on the filler. Independently thereof, an aqueous slurry of at least one unswollen starch is prepared. This is subjected as described above to a swelling process in which hot water is mixed with the aqueous slurry. The swelling process is stopped by either adding cold water to the warm aqueous starch slurry or mixing the warm aqueous starch slurry directly with the aqueous slurry comprising at least one finely divided filler and at least one water-soluble amphoteric copolymer if the said aqueous slurry has a temperature substantially lower than the warm aqueous starch slurry. The metered amount of the starch is, for example, from 0.1 to 10% by weight, preferably from 0.5 to 5% by weight, based on the filler.

In the third variant (C), aqueous slurries or solutions of all components—starch, water-soluble amphoteric copolymer and filler—are prepared separately from one another. The swelling of the starch is effected in the absence of water-soluble copolymer and filler. The aqueous slurries or solutions of all components are then mixed together in any desired sequence, but first the addition of the aqueous slurry of at least one finely divided filler to the aqueous slurry of the at least one swollen starch and then the addition of the aqueous solution of the at least one water-soluble amphoteric copolymer to this mixture is preferred. The metered amount of the swollen starch is, for example, from 0.1 to 10% by weight, preferably from 0.5 to 5% by weight, based on the filler. The metered amount of the water-soluble amphoteric copolymer is, for example, from 0.01 to 5% by weight, preferably from 0.05 to 2.5% by weight and particularly preferably from 0.05 to 1% by weight, based on the filler.

The treatment of the aqueous slurry of finely divided fillers with the water-soluble amphoteric copolymers and the swollen starch can be carried out continuously or batchwise, independently of the sequence of addition of the aqueous slurries or solutions of the components—starch, water-soluble amphoteric copolymer and filler. On combination of aqueous slurries of finely divided fillers, aqueous slurries of swollen starch and aqueous solutions of water-soluble amphoteric copolymers, the filler particles are at least partly coated or impregnated with the water-soluble amphoteric copolymers and the swollen starch.

The mixing of the components is effected, for example, in a shear field. In general, it is sufficient if the components are stirred or are treated in a shear field of Ultraturrax apparatus after combination. The combination and mixing of the constituents of the aqueous slurries can be effected, for example, in the temperature range from 0° C. to 60° C., preferably from 10 to 50° C. In general, the components are mixed at the respective room temperature up to a temperature of 40° C. The pH of the aqueous slurries of finely divided fillers, which slurries have been treated with water-soluble amphoteric copolymers and swollen starch, is, for example, from 5 to 11, preferably from 6 to 9, the pH of slurries comprising calcium carbonate preferably being more than 6.5.

The water-soluble amphoteric copolymers have a relatively large number of ionically dissociatable/dissociated groups of opposite chargeability/charge which are bonded to the polymer chain. On bringing into contact with aqueous slurries of finely divided fillers Coulomb interactions may occur. On bringing into contact, in general at least partial occupation of the surface of the polymer particles thus takes place. This can be shown, for example, by transmission electron microscopy (TEM). The surface charge can additionally be measured by zeta potential measurements, which show that the charge is on the outside. The electrophoretic mobility and the zeta potential can be determined by a laser optical method. For example, a Zetasizer 3000 HS from Malvern Instruments Ltd. is used as a metric instrument.

The invention furthermore relates to the use of the aqueous slurries described above as an additive to the paper stock in the production of filler-containing paper, filler-containing cardboard or filler-containing board by drainage of the paper stock.

The invention also relates to papers which are produced using the aqueous slurries of finely divided filler according to the invention.

Specifically, these are filler-containing papers such as, for example, wood-free uncoated printing, writing or copying paper and wood-containing uncoated papers such as, for example, recycled newsprint or SC papers for the offset or gravure printing sector. By treatment of the filler added to the paper with swollen starch in combination with a water-soluble amphoteric copolymer, the filler content of the paper can be substantially increased with virtually unchanged strength properties. The filler-containing papers, cardboards and boards obtained using the aqueous slurries according to the invention have strength properties which are comparable with those of conventional papers having a low solids content.

The fillers pretreated by the process described above are mixed with the fiber in order thus to form the total paper stock. In addition to the treated fillers and fibers the total stock may also comprise other conventional paper additives. These include, for example, sizes, such as alkylketene dimers (AKD), alkenylsuccinic anhydrides (ASA), rosin size, wet strength agents, cationic or anionic retention aids based on synthetic polymers. Suitable retention aids are, for example, anionic microparticles (colloidal silica, bentonite), anionic polyacrylamides, cationic polyacrylamides, cationic starch, cationic polyethylenimine or cationic polyvinylamine. In addition, any desired combinations thereof are conceivable, such as, for example, dual systems, which consist of a cationic polymer with an anionic microparticle or an anionic polymer with a cationic microparticle.

The invention is explained in more detail with reference to the following, nonlimiting examples.

The stated percentages in the examples are percentages by weight, unless evident otherwise from the context.

In the examples, the following amphoteric copolymers are used:
Copolymer 1: water-soluble amphoteric copolymer having a molecular weight M_{w} of about 500 000 g/mol, corresponding to example 1 from WO 2004/087818; having content of 40 mol % of vinylformamide units, 30 mol % of acrylic acid units and 30 mol % of vinylamine and amide units

### EXAMPLE 1

Cationic waxy corn starch having a degree of substitution of 0.035 was suspended in water at 25° C. to give a 20% strength by weight slurry. 20 g of a 12% strength by weight aqueous solution of the amphoteric copolymer 1 were added to 100 ml of this slurry. The mixture was then diluted with 400 ml of hot water (75° C.) and gently stirred for 90 seconds. Thereafter, 25 ml of the dilute slurry were taken and placed in a beaker. Thereafter, 150 g of a 20% strength by weight slurry of precipitated calcium carbonate (PCC) in water were added. During the addition of the PCC slurry and thereafter, the mixture was stirred at 1000 revolutions per minute (rpm) with the aid of a Heiltof stirrer. The pH of the mixture was then adjusted to 8.5.

### EXAMPLE 2

1 g of a 12% strength by weight aqueous solution of the amphoteric copolymer 1 were initially taken in a beaker and then diluted with 30 g of water. Thereafter, 150 g of a 20% strength by weight slurry of precipitated calcium carbonate (PCC) in water were added. During the addition of the PCC slurry and thereafter, the mixture was stirred at 1000 rpm with the aid of a Heiltof stirrer. After approximately 60 seconds of stirring time, 25 ml of a 4% strength by weight starch slurry (prepared from a cationic waxy corn starch having a degree of substitution of 0.035, initially as 20% strength by weight slurry diluted with hot water (75° C.) to 4% by weight solids content and swollen for 90 seconds) were added. During the addition of the starch slurry, the mixture was stirred at 500 rpm with the aid of the Heiltof stirrer. The pH of the mixture was then adjusted to 8.5.

### EXAMPLE 3

Cationic waxy corn starch having a degree of substitution of 0.035 was suspended in water at 25° C. to give a 20% strength by weight slurry. 100 ml of this starch slurry were then diluted with 400 ml of hot water (75° C.) and gently stirred for 90 seconds. Thereafter, 25 ml of the dilute slurry were taken and placed in a beaker. Thereafter, 150 g of a 20% strength by weight slurry of precipitated calcium carbonate (PCC) in water were added. Then 1 g of a 12% strength by weight aqueous solution of the amphoteric copolymer 1 was added to this pretreated filler slurry. During the addition of the PCC slurry and thereafter, the mixture was stirred at 1000 rpm with the aid of a Heiltof stirrer. The pH of the mixture was then adjusted to 8.5.

### COMPARATIVE EXAMPLE 1

### Comparison According to WO 04/087818

### EXAMPLE 1

1 g of a 12% strength by weight aqueous solution of the amphoteric copolymer 1 was initially taken in a beaker and then diluted with 30 g of water. Thereafter, 150 g of a 20% strength by weight slurry of precipitated calcium carbonate (PCC) in water were added. During the addition of the PCC slurry and thereafter, the mixture was stirred at 1000 rpm with the aid of a Heiltof stirrer. The pH of the mixture was then adjusted to 8.5.

### COMPARATIVE EXAMPLE 2

Cationic waxy corn starch having a degree of substitution of 0.035 was suspended in water at 25° C. to give a 20% strength by weight slurry. The total volume of the slurry was 100 ml. This mixture was then diluted with 400 ml of hot water (75° C.) and gently stirred for 90 seconds. Thereafter, 25 ml of the dilute starch slurry were taken and placed in a beaker. Thereafter, 150 g of a 20% strength by weight slurry of precipitated calcium carbonate (PCC) in water were added. During the addition of the PCC slurry and thereafter, the mixture was stirred at 1000 rpm with the aid of a Heiltof stirrer. The pH of the mixture was then adjusted to 8.5.

### COMPARATIVE EXAMPLE 3

### Comparison According to WO 03/087472)

Cationic waxy corn starch having a degree of substitution of 0.035 was suspended in water at 25° C. to give a 20% strength by weight slurry. 1.8 g of a 50% strength by weight dispersion of an anionic latex were then admixed (Acronal® S504, BASF Aktiengesellschaft). This mixture was then diluted with 400 ml of hot water (75° C.) and gently stirred for 90 seconds. Thereafter, 25 ml of the dilute slurry were taken and placed in a beaker. Thereafter, 150 g of a 20% strength by weight aqueous slurry of precipitated calcium carbonate (PCC) were added with gentle stirring. During the addition of the PCC slurry and thereafter, the mixture was stirred at 1000 rpm with the aid of a Heiltof stirrer. The pH of the mixture was then adjusted to 8.5.

Production of filler-containing paper

### EXAMPLES 4-12

### COMPARATIVE EXAMPLES 4-15

A mixture of bleached birch sulfate and bleached pine sulfite was beaten gel-free in the ratio of 70/30 at a solids concentration of 4% in a laboratory pulper until a freeness of 30-35 was reached. An optical brightener (Blankophor® PSG, Bayer AG) and a cationic starch (HiCat® 5163 A) were then added to the beaten stock. The digestion of the cationic starch was effected as 10% strength by weight starch slurry in a jet digester at 130° C. and with a residence time of 1 minute. The metered amount of the optical brightener was 0.5% by weight of commercial product, based on the solids content of the paper stock suspension. The metered amount of the cationic starch was 0.5% by weight of starch, based on the solids content of the paper stock suspension. The pH of the stock was in the range from 7 to 8. The beaten stock was then diluted to a solids concentration of 0.35% by weight by addition of water.

In order to determine the behavior of the aqueous filler slurries described above in the production of filler-containing paper, in each case 500 ml of the paper stock suspension were initially taken and in each case the slurries treated according to the examples and a cationic polyacrylamide as a retention aid (Polymin® KE 2020, BASF Aktiengesellschaft) were metered into this pulp. The metered amount of the retention aid was in all cases 0.01% by weight of polymer, based on the solids content of the paper stock suspension.

Sheets with the pretreated fillers described above were then formed (examples 4-12 and comparative examples 4-12). The amount of filler used for this purpose was adapted so that the filler contents were about 20%, 30% and 40%. In the case of the pretreated fillers, the amount of slurry which has to be used in order to achieve a certain target value is always smaller than in the case of the untreated fillers.

In addition, comparative examples with untreated filler were carried out for each of the pretreated filler types (comparative examples 13-15). For this purpose, the amount of untreated filler slurry which is required in order to establish a filler content of about 20%, 30% and 40% was first determined in preliminary experiments. Sheets with the untreated fillers were then formed.

The paper sheets were produced in each case on a Rapid-Köthen sheet former according to ISO 5269/2, with a sheet weight of 70 g/m², and then dried for 7 minutes at 90° C.

Testing of the paper sheets

After a storage time in a conditioned chamber at a constant 23° C. and 50% relative humidity for 12 hours, the dry breaking length of the sheets was determined according to DIN 54540 and the internal bonding strength according to DIN 54516 and the stiffness according to DIN 53121. The results are stated in table 1. The slurries corresponding to the comparative examples or the comparative examples with the paper sheets produced therefrom are characterized by the addition (CE). The other examples are examples according to the invention.

TABLE 1

| | Slurry | | | | |
|---|---|---|---|---|---|
| | according to | | Dry | Internal | |
| Example or | example or | Filler | breaking | bonding | Stiff- |
| comparative | comparative | content | length | strength | ness |
| example (CE) | example (CE) | [%] | [m] | [N] | [mN] |
| 4 | 1 | 19.5 | 5698 | 389 | 81.4 |
| 5 | 1 | 30.3 | 4678 | 301 | 66.2 |
| 6 | 1 | 39.5 | 4187 | 245 | 51.7 |
| 7 | 2 | 18.9 | 5659 | 367 | 84.9 |
| 8 | 2 | 29.7 | 4578 | 312 | 65.3 |
| 9 | 2 | 38.9 | 4265 | 231 | 53.6 |
| 10 | 3 | 20.3 | 5563 | 372 | 78.9 |
| 11 | 3 | 29.1 | 4576 | 312 | 67.2 |
| 12 | 3 | 38.8 | 4137 | 251 | 50.1 |
| 4 (CE) | 1 (CE) | 20.2 | 4675 | 257 | 78.4 |
| 5 (CE) | 1 (CE) | 29.5 | 3701 | 153 | 43.9 |
| 6 (CE) | 1 (CE) | 40.3 | 2815 | 101 | 30.5 |
| 7 (CE) | 2 (CE) | 20.3 | 4945 | 295 | 74.3 |
| 8 (CE) | 2 (CE) | 29.6 | 4025 | 214 | 44.5 |
| 9 (CE) | 2 (CE) | 39.7 | 3112 | 122 | 31.2 |
| 10 (CE) | 3 (CE) | 21.1 | 5189 | 305 | 76.1 |
| 11 (CE) | 3 (CE) | 30.9 | 4212 | 234 | 46.9 |
| 12 (CE) | 3 (CE) | 39.4 | 3218 | 167 | 33.5 |
| 13 (CE) | PCC without | 20.4 | 4389 | 226 | 73.1 |
| | pretreatment | | | | |
| 14 (CE) | PCC without | 30.5 | 3224 | 132 | 41.8 |
| | pretreatment | | | | |
| 15 (CE) | PCC without | 39.4 | 2298 | 84 | 28.4 |
| | pretreatment | | | | |

1. An aqueous slurry comprising at least one finely divided filler which is at least partly coated with a composition comprising at least one water-soluble amphoteric copolymer and at least one swollen starch.

2. The aqueous slurry according to claim 1, wherein the aqueous slurry is obtained by a process comprising treating an aqueous slurry comprising at least one finely divided filler with at least one water-soluble amphoteric copolymer and at least one swollen starch, wherein the water-soluble amphoteric copolymer is obtained by: copolymerization of a monomer mixture of
(a) at least one N-vinylcarboxamide of general formula (1) 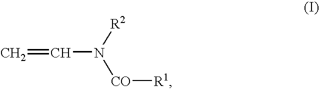
where R¹ and R², independently of one another, are H or C₁- to C₆-alkyl,
(b) at least one monomer which is selected from the group consisting of
(b₁) monoethylenically unsaturated sulfonic acids, phosphonic acids, phosphoric acid esters and derivatives thereof and
(b₂) monoethylenically unsaturated mono- and dicarboxylic acids, salts thereof and dicarboxylic anhydrides,
(c) optionally, at least one monoethylenically unsaturated monomer differing from the components (a) and (b), and
(d) optionally, at least one compound which has at least two ethylenically unsaturated double bonds in the molecule,
wherein the monomer mixture comprises at least one monomer (b) having at least one of free acid group and an acid group in salt form;
and subsequent partial or complete hydrolysis of the groups —CO—R¹ of the monomers (a) in the form of polymerized units in the copolymer.

3. The aqueous slurry according to claim 1, wherein the aqueous slurry is obtained by treating an aqueous slurry comprising at least one finely divided filler with at least one water-soluble amphoteric copolymer and at least one swollen starch, wherein the water-soluble amphoteric copolymer is obtained by: copolymerization of a monomer mixture of
(a) at least one N-vinylcarboxamide of general formula (1) 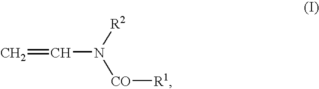
where R¹ and R², independently of one another, are H or C₁- to C₆-alkyl,
(b) at least one monomer from the group (b₂) which is selected from the group consisting of monoethylenically unsaturated carboxylic acids having 3 to 8 carbon atoms and the water-soluble salts of the carboxylic acids,
(c) optionally, at least one monoethylenically unsaturated monomer differing from the components (a) and (b), and
(d) optionally, at least one compound which has at least two ethylenically unsaturated double bonds in the molecule;
and subsequent partial or complete hydrolysis of the groups —CO—R¹ of the monomers (a) in the form of polymerized units in the copolymer.

4. The aqueous slurry according to claim 1, wherein the aqueous slurry is obtained by treating an aqueous slurry comprising at least one finely divided filler with at least one water-soluble amphoteric copolymer and at least one swollen starch, wherein the water-soluble amphoteric copolymer is obtained by: copolymerization of a monomer mixture of
(a) N-vinylformamide,
(b) at least one of acrylic acid, methacrylic acid, and the alkali metal or ammonium salts thereof, and
(c) optionally, other monoethylenically unsaturated monomers;
and subsequent partial or complete hydrolysis of the vinylformamide units present in the copolymers.

5. The aqueous slurry according to claim 2, wherein the hydrolysis of the vinylformamide units present in the copolymers is effected by acids, bases or enzymes.

6. The aqueous slurry according to claim 2, wherein the degree of hydrolysis of the vinylcarboxamide groups in the form of polymerized units is from 0.1 to 100 mol %.

7. The aqueous slurry according to claim 2, wherein the hydrolyzed copolymers comprise
(i) from 1 to 98 mol % of vinylcarboxamide units,
(ii) from 1 to 98 mol % of units of monoethylenically unsaturated sulfonic acids, phosphonic acids, phosphoric acid esters or derivatives thereof, or units of monoethylenically unsaturated mono- and dicarboxylic acids, salts thereof and dicarboxylic anhydrides of at least one monoethylenically unsaturated carboxylic acid having 3 to 8 carbon atoms,
(iii) from 1 to 98 mol % of at least one of vinylamine units of formula (II) and amidine units of at least one of formula (III) and (IV) 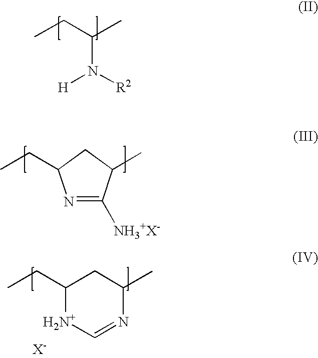
where, in the amidine units (III) and (IV), X⁻ in each case is an anion, and
(iv) up to 30 mol % of units of other monoethylenically unsaturated compounds.

8. The aqueous slurry according to claim 7, wherein the hydrolyzed copolymers comprise
(i) from 5 to 70 mol % of vinylcarboxamide units,
(ii) from 3 to 30 mol % of units of monoethylenically unsaturated sulfonic acids, phosphonic acids and salts thereof, or from 5 to 45 mol % of units of acrylic acid, methacrylic acid, salts and mixtures thereof, and
(iii) from 10 to 50 mol % of at least one of vinylamine units in salt form and amidine units of at least one of formula (III) and (IV).

9. The aqueous slurry according to claim 1, wherein the aqueous slurry is obtained by treating an aqueous slurry comprising at least one finely divided filler with at least one water-soluble amphoteric copolymer and at least one swollen starch, wherein the water-soluble amphoteric copolymer is obtained by copolymerization of a monomer mixture of
(b) at least one monomer which is selected from the group consisting of
(b₁) monoethylenically unsaturated sulfonic acids, phosphonic acids, phosphoric acid esters and derivatives thereof, and
(b₂) monoethylenically unsaturated mono- and dicarboxylic acids, salts thereof and dicarboxylic anhydrides,
(e) at least one ethylenically unsaturated monomer which carries at least one of a cationic group and a group to which a cationic charge is imparted by protonation,
(f) optionally, at least one monoethylenically unsaturated monomer differing from the components (b) and (e), and
(d) optionally, at least one compound which has at least two ethylenically unsaturated double bonds in the molecule.

10. The aqueous slurry according to claim 1, wherein the aqueous slurry is obtained by treating an aqueous slurry comprising at least one finely divided filler with at least one water-soluble amphoteric copolymer and at least one swollen starch, wherein the water-soluble amphoteric copolymer is obtained by copolymerization of a monomer mixture of
(b) at least one monomer from the group (b₂) which is selected from the group consisting of monoethylenically unsaturated carboxylic acids having 3 to 8 carbon atoms and the water-soluble salts of the carboxylic acids,
(e) at least one ethylenically unsaturated monomer which is selected from the group consisting of the esters of α,β-ethylenically unsaturated mono- and dicarboxylic acids with C₂-C₁₂-amino alcohols which are optionally C₁-C₈-monoalkylated or C₁-C₈-dialkylated on the amine nitrogen, and quaternization products of the esters with C₁-C₈-alkyl chlorides, C₁-C₈-dialkyl sulfates, C₁-C₁₆-epoxides or benzyl chloride,
(f) optionally, at least one monoethylenically unsaturated monomer which differs from the components (b) and (e) and is selected from the group consisting of the N-vinylcarboxamides of general formula (I) 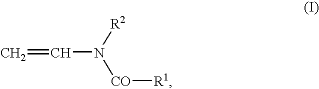
where R¹ and R² independently of one another, are H or C₁- to C₆-alkyl, (meth)acrylamides and (meth)acrylonitriles, and
(d) optionally, at least one compound which has at least two ethylenically unsaturated double bonds in the molecule.

11. The aqueous slurry according to claim 1, wherein the aqueous slurry is obtained by treating an aqueous slurry comprising at least one finely divided filler with at least one water-soluble amphoteric copolymer and at least one swollen starch, wherein the water-soluble amphoteric copolymer is obtained by copolymerization of a monomer mixture of
(b) at least one of acrylic acid, methacrylic acid, and the alkali metal or ammonium salts thereof,
(e) dimethylaminoethyl (meth)acrylate methochloride, and
(f) at least one of N-vinylformamide, acrylamide and acrylonitrile.

12. The aqueous slurry according to claim 1, wherein the aqueous slurry comprises from 1 to 70% by weight of at least one finely divided filler.

13. The aqueous slurry according to claim 1, wherein the amount of water-soluble amphoteric copolymer is from 0.01 to 5% by weight, based on the filler.

14. The aqueous slurry according to claim 1, wherein the starch is cationic, anionic or amphoteric.

15. The aqueous slurry according to claim 1, wherein the starch is a natural starch selected from the group consisting of potato, corn, rice and tapioca starch or a chemically modified starch.

16. The aqueous slurry according to claim 1, wherein the amount of starch is from 0.1 to 10% by weight, based on the filler.

17. A process for the preparation of the aqueous slurry according to claim 1, comprising treating an aqueous slurry comprising at least one finely divided filler with from 0.01 to 5% by weight, based on the filler, of at least one water-soluble amphoteric copolymer and with from 0.1 to 10% by weight, based on the filler, of at least one swollen starch.

18. The process according to claim 17, wherein the water-soluble amphoteric copolymer is obtained by: copolymerization of a monomer mixture of
(a) at least one N-vinylcarboxamide of general formula 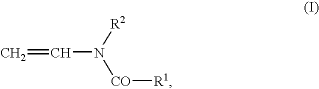
where R¹ and R² independently of one another, are H or C₁- to C₆-alkyl,
(b) at least one monomer which is selected from the group consisting of
(b₁) monoethylenically unsaturated sulfonic acids, phosphonic acids, phosphoric acid esters and derivatives thereof and
(b₂) monoethylenically unsaturated mono- and dicarboxylic acids, salts thereof and dicarboxylic anhydrides,
(c) optionally, at least one monoethylenically unsaturated monomer differing from the components (a) and (b), and
(d) optionally, at least one compound which has at least two ethylenically unsaturated double bonds in the molecule,
wherein the monomer mixture comprises at least one monomer (b) having at least one of free acid group and an acid group in salt form;
and subsequent partial or complete hydrolysis of the groups —CO—R¹ from the monomers (a) in the form of polymerized units in the copolymer.

19. The process according to claim 17, wherein the water-soluble amphoteric copolymer is obtained by copolymerization of a monomer mixture of
(b) at least one monomer which is selected from the group consisting of
(b₁) monoethylenically unsaturated sulfonic acids, phosphoric acids, phosphoric acid esters and derivatives thereof, and
(b₂) monoethylenically unsaturated mono- and dicarboxylic acids, salts thereof and dicarboxylic anhydrides,
(e) at least one ethylenically unsaturated monomer which carries at least one of a cationic group and a group to which a cationic charge is imparted by protonation,
(f) optionally, at least one monoethylenically unsaturated monomer differing from the components (b) and (e), and
(d) optionally, at least one compound which has at least two ethylenically unsaturated double bonds in the molecule.

20. The process according to claim 17, comprising:
(A) preparing an aqueous slurry comprising at least one unswollen starch and at least one water-soluble amphoteric copolymer, subsequently swelling the starch, and adding an aqueous slurry of at least one finely divided filler to the starch-copolymer composition,
(B) preparing an aqueous slurry comprising at least one finely divided filler and at least one water-soluble amphoteric copolymer, preparing an aqueous slurry of at least one unswollen starch, subsequent swelling of the starch, mixing the two aqueous slurries, or
(C) preparing an aqueous slurry comprising at least one unswollen starch, swelling the starch, adding an aqueous slurry of at least one finely divided filler, subsequently adding an aqueous solution of at least one water-soluble amphoteric copolymer to the aqueous slurry comprising the at least one swollen starch.

21. A paper stock comprising the aqueous slurries according to claim 1.

22. (canceled)
